(19) United States
(12) Patent Application Publication
(10) Pub. No.: US 2013/0164541 A1
(43) Pub. Date: Jun. 27, 2013

(54) CURABLE RESIN COMPOSITION AND MULTI-LAYER LAMINATE MANUFACTURED USING THE SAME

(71) Applicants: Toshihiro Suwa, Sagamihara-city (JP); Hideyuki Hatanaka, Hachioji-shi (JP)

(72) Inventors: Toshihiro Suwa, Sagamihara-city (JP); Hideyuki Hatanaka, Hachioji-shi (JP)

(73) Assignee: 3M INNOVATIVE PROPERTIES COMPANY, ST. PAUL, MN (US)

(21) Appl. No.: 13/820,819

(22) PCT Filed: Sep. 7, 2010
(86) PCT No.: PCT/US2010/047974

§ 371 Date: Mar. 5, 2013

(51) Int. Cl. C08G 18/68

(52) U.S. Cl. CPC C08G 18/68
USPC 428/412; 522/39; 428/424.2; 427/520

(57) ABSTRACT

A multi-layer laminate includes a substrate and a resin layer. The substrate has an acrylic anti-abrasion coating layer on at least one surface. The resin layer is formed on the acrylic anti-abrasion coating layer and includes a polymerization product of a curable resin composition. The curable resin composition includes a (meth)acrylate having one or more hydroxyl groups in the molecule, a (meth)acrylate having two or more (meth)acryloyl groups in the molecule, a polyisocyanate having three or more isocyanate groups in the molecule and a photoinitiator.

### TECHNICAL FIELD

The present invention relates to a curable resin composition that shows excellent adhesion onto a substrate having an anti-abrasion coating layer and a multi-layer laminate manufactured using the same.

### BACKGROUND

(Meth)acrylic resin sheets mainly composed of methyl methacrylate (MMA) have excellent clarity, weathering resistance, mechanical strength, and are easily processable. Therefore, they are used in a variety of fields such as optical goods, lighting fixtures, signboards, and building materials. Considering especially their well-balanced optical performance, these (meth)acrylic resin sheets are particularly used as protective screen covers for mobile phones, portable gaming systems, and the like. On the other hand, (meth)acrylic resin lacks sufficient abrasion resistance and surface hardness and therefore (meth)acrylic resin sheets, when used as protective covers, are generally provided with an anti-abrasion coating layer on the surface. An example of an anti-abrasion coating layer that has been used widely conventionally is an acrylic anti-abrasion coating layer in which a polymerizable composition including a multi-functional (meth)acrylate is cured by heat or radiation curing.

On the other hand, conventionally, a UV-curable resin for filling a printing layer has generally been formed on back sides of transparent resin sheets, or, in other words, on a side to which an adhesive sheet (PSA sheet) is adhered. However, in recent years, asperities and the like are being formed on outermost surfaces of the transparent resin sheets.

Japanese Unexamined Patent Application No. 2004-010728 describes a “UV-curable composition having excellent abrasion resistance and that can form a cured coating with excellent adhesion to a base material including a photoinitiator and a UV-curable urethane (meth)acrylate oligomer obtained by reacting an isocyanate compound, a hydroxyl group modified polyorganosiloxane, and a hydroxyl group-containing multi-functional (meth)acrylate compound.

Japanese Unexamined Patent Application No. 2009-214546 describes a “resin sheet having fine decorative patterns formed by laminating a three-dimensional cured resin layer on top of a transparent resin sheet.”

### SUMMARY

A multi-layer laminate further provided with a resin layer adhered on top of an anti-abrasion coating layer and a curable resin composition having excellent adhesion onto an anti-abrasion coating layer, preferably, a curable resin composition having an ability to fill topography on an anti-abrasion coating layer, or preferably a curable resin composition capable of forming fine three-dimensional structures on an outermost surface layer of an anti-abrasion coating layer are needed.

According to an aspect of the present disclosure, a multi-layer laminate including a substrate having an acrylic anti-abrasion coating layer on at least one surface and a resin layer formed on the acrylic anti-abrasion coating layer is provided, wherein the resin layer comprises a polymerization product of a curable resin composition including (i) a (meth)acrylate having one or more hydroxyl groups in the molecule; (ii) a (meth)acrylate having two or more (meth)acryloyl groups in the molecule; (iii) a polyisocyanate having three or more isocyanate groups in the molecule; and (iv) a photoinitiator.

According to another aspect of the present disclosure, a multi-layer laminate is provided in which the resin layer further includes (v) silica nanoparticles (filler).

Additionally, according to yet another aspect of the present disclosure, a manufacturing method for a multi-layer laminate is provided including the steps of: preparing a substrate having an acrylic anti-abrasion coating layer on at least one surface; preparing a curable resin composition including: (i) a (meth)acrylate having one or more hydroxyl groups in the molecule; (ii) a multi-functional (meth)acrylate having two or more (meth)acryloyl groups in the molecule; (iii) a polyisocyanate having three or more isocyanate groups in the molecule; and (iv) a photoinitiator; applying the curable resin composition on the acrylic anti-abrasion coating layer; radiation curing the curable resin composition; and heat curing the curable resin composition.

Additionally, according to yet another aspect of the present disclosure, a manufacturing method for a multi-layer laminate is provided including the steps of: preparing a substrate having an acrylic anti-abrasion coating layer on at least one surface; preparing a curable resin composition including: (i) a (meth)acrylate having one or more hydroxyl groups in the molecule; (ii) a multi-functional (meth)acrylate having two or more (meth)acryloyl groups in the molecule; (iii) a polyisocyanate having three or more isocyanate groups in the molecule; (iv) silica nanoparticles (filler); and (v) a photoinitiator; applying the curable resin composition on the acrylic anti-abrasion coating layer; radiation curing the curable resin composition; and heat curing the curable resin composition.

Additionally, according to yet another aspect of the present disclosure, a curable resin composition is provided including: (i) a (meth)acrylate having one or more hydroxyl groups in the molecule; (ii) a multi-functional (meth)acrylate having two or more (meth)acryloyl groups in the molecule; (iii) a polyisocyanate having three or more isocyanate groups in the molecule; and (iv) a photoinitiator.

Additionally, according to yet another aspect of the present disclosure, a curable resin composition is provided in which the aforementioned curable resin composition further includes (v) silica nanoparticles (filler).

The multi-layer laminate of the present disclosure has excellent adhesion between the acrylic anti-abrasion coating layer and the resin layer. Therefore, the resin layer will not easily separate from the substrate at times of bending or machining or become damaged. Additionally, it is possible to make the resin layer comparatively thick (i.e. from about 10 to 100 μm). Therefore, the multi-layer laminate will have a surface that has topography (for example, having heights from about 1 to 50 μm) on the substrate filled or a surface that has fine three-dimensional structures on the substrate.

Additionally, when the multi-layer laminate of the present disclosure contains silica nanoparticles (filler), it can further be used as a structural material layer with excellent surface hardness because sufficient surface scratch resistance of the resin layer can be obtained.

By using the curable resin composition of the present disclosure, a resin layer having excellent adhesion to an acrylic anti-abrasion coating layer can be formed. Furthermore, when the silica nanoparticles (filler) are included, a resin layer simultaneously having sufficient surface hardness can be formed. Additionally, by using the curable resin composition, fine uneven surfaces on film substrates can be filled or fine three-dimensional structures can be formed on substrates.

Note that the above descriptions should not be construed to be a disclosure of all of the embodiments and benefits of the present invention.

### BRIEF DESCRIPTION OF THE DRAWINGS

FIG. 1 is a cross sectional view of a multi-layer laminate of an aspect of the present disclosure.

FIG. 2 is a simplified cross sectional view showing a multi-layer laminate according to an aspect of the present disclosure, an image display device or optical member, and an adhesive layer there between for use as a protective film for an image display device or optical member.

FIG. 3 is a cross sectional view of a multi-layer laminate of an aspect of the present disclosure showing a resin layer provided with fine three-dimensional structures on a surface and having an anti-reflection feature.

FIG. 4 is a cross sectional view of a multi-layer laminate of an aspect of the present disclosure showing fine grooves formed on a surface of the resin layer for decorative purposes.

### DETAILED DESCRIPTION

A detailed explanation for the purpose of illustrating representative embodiments of the present invention are given below, but these embodiments should not be construed to limit the present invention.

As used herein, the terms “(meth)acryl”, “(meth)acrylate”, and “(meth)acryloyl” include acryl and methacryl, acrylate and methacrylate, and acryloyl and methacryloyl, respectively.

A multi-layer laminate of the present disclosure includes a substrate having an acrylic anti-abrasion coating layer and a resin layer provided on the acrylic anti-abrasion coating layer. Since the resin layer is adhered to the acrylic anti-abrasion coating layer, the resin layer will not easily peel or separate from the substrate at times of bending or machining. Furthermore, the inclusion of silica nanoparticles (filler) in the multi-layer laminate provides the multi-layer laminate with satisfactory surface hardness.

The substrate can be of any configuration such as a film, sheet, panel, or other molded product. The substrate is made from a material onto a surface of which an acrylic anti-abrasion coating layer can be provided, examples of which include (meth)acrylic resins (such as polymethylmethacrylate (PMMA)), polycarbonates, polyesters (such as polyethylene terephthalate and polyethylene naphthalate), polystyrenes, polyolefins (such as polyethylene and polypropylene), glass, ceramics, metals, and combinations thereof. Substrates for the multi-layer laminate that have excellent hardness and/or strength such as (meth)acrylic resin, polycarbonates, glass, ceramics, or metals are preferable. For applications where clarity is needed, (meth)acrylic resins, polycarbonates, or glass is particularly preferable. The substrate itself may by a structure formed from one or more layers (such as a laminate sheet) and examples of such layers include (meth)acrylic resin layers, polycarbonate layers, and the like. When using a polycarbonate film or sheet as the substrate, it is beneficial to provide a (meth)acrylic resin layer on one or both sides in order to increase the hardness.

The acrylic anti-abrasion coating layer provided on the surface of the substrate is a layer formed from a polymerizable composition having multi-functional (meth)acrylate as its main ingredient and photo or thermal initiators; other polymerizable monomers such as silicon modified acrylate; dilution monomers; inorganic ingredients such as silica gel, pigments, metallic oxides, and the like; and other additives may be added as necessary. The thickness of conventionally used acrylic anti-abrasion coating layers is about 1 μm or more or about 5 μm or more and about 30 μm or less or 10 μm or less. The acrylic anti-abrasion coating layer is formed, for example, by applying the polymerizable composition to the substrate and then applying heat or radiation to cure the polymerizable composition. In cases when the substrate is a film, sheet, panel, or the like, the acrylic anti-abrasion coating layer may be provided on only one side or on both sides of the substrate. When the acrylic anti-abrasion coating layer is provided on both sides of the substrate, materials and/or thicknesses of the anti-abrasion coating layers may be the same or different.

Examples of such commercially available substrates having acrylic anti-abrasion coating layers include (meth)acrylic resin substrates such as ACRYLITE® MR-200 (manufactured by Mitsubishi Rayon Co., Ltd.), SUMIPEX® E MR (manufactured by Sumitomo Chemical Co., Ltd.), SUMIELEC® II (manufactured by Sumitomo Chemical Co., Ltd.), Delaglas™ HAS (Asahi Kasei Corporation), and the like; and polycarbonate/(meth)acrylic resin composite plates such as SUMIELEC® CW06 (manufactured by Sumitomo Chemical Co., Ltd.), and the like.

The resin layer is provided on the acrylic anti-abrasion coating layer and is formed by a polymerization product of a curable resin composition. The curable resin composition includes the following ingredients: (i) a (meth)acrylate having one or more hydroxyl groups in the molecule; (ii) a (meth)acrylate having two or more (meth)acryloyl groups in the molecule; (iii) a polyisocyanate having three or more isocyanate groups in the molecule; and (iv) a photoinitiator. Furthermore, as necessary, the polymerization product of the curable resin composition of the resin layer may include silica nanoparticles (filler).

The (meth)acryloyl parts of the (i) (meth)acrylate having one or more hydroxyl groups in the molecule polymerizes with the (meth)acrylate of the ingredient (ii) and other polymerizable ingredients at a time of radiation and/or thermal curing, radiation curing being preferred, forming polymer chains. The hydroxyl groups react with the isocyanate groups at a time of thermal curing to form urethane bonds. Examples of the (meth)acrylate having one or more hydroxyl groups in the molecule include, for example, hydroxyalkyl (meth)acrylates having from 2 to 8 carbon atoms such as hydroxyethyl (meth)acrylate, hydroxybutyl (meth)acrylate, and the like; hydroxyl group-containing (meth)acrylates obtained from an esterification reaction of a diol compound such as ethylene glycol, 1,6-hexanediol, neopentyl glycol, polyethylene glycol, polypropylene glycol, polybutylene glycol, or the like and a carboxyl group-containing unsaturated monomer such as (meth)acrylic acid, or the like; hydroxyl group-containing (meth)acrylates obtained by reacting glycidyl (meth)acrylate with an acid such as acetic acid, propionic acid, p-tert-butyl benzoic acid, fatty acids, or the like or a monoamine such as alkylamine or the like; bis(acryloyloxyethyl)hydroxyethyl isocyanurate; and combinations thereof. Of the aforementioned (meth)acrylates, those with small molecular weights may also simultaneously function as diluents. Particularly, bis(acryloyloxyethyl)hydroxyethyl isocyanurate can be advantageously used as it has exhibits little cure shrinkage and excellent adhesion.

The (ii) (meth)acrylate having two or more (meth)acryloyl groups in the molecule polymerizes at a time of radiation curing and/or thermal curing, radiation curing being preferred, to form crosslinked parts in the polymer chain, which relates to properties of the resin layer such as surface hardness, strength, film/membrane formability, and the like. Examples of the (meth)acrylate include, for example, bifunctional acrylates such as polyethylene glycol diacrylate, ethoxylated bisphenol A diacrylate, propoxylated bisphenol A diacrylate, 1,10-decanediol diacrylate, tricyclodecane dimethanol diacrylate, ethoxylated 2-methyl-1,3-propanediol diacrylate, neopentyl glycol diacrylate, 2-hydroxy-3-acryloyloxy propyl acrylate, propoxylated ethoxylated bisphenol A diacrylate, 1,6-hexanediol diacrylate, 1,9-nonanediol diacrylate, dipropylene glycol diacrylate, tripropylene glycol diacrylate, polypropylene glycol diacrylate, bis(acryloyloxyethyl)hydroxyethyl isocyanurate, and the like; bifunctional methacrylates such as ethylene glycol dimethacrylate, diethylene glycol dimethacrylate, triethylene glycol dimethacrylate, tetraethylene glycol dimethacrylate, polyethylene glycol dimethacrylate, 1,3-butanediol dimethacrylate, 1,4-butanediol dimethacrylate, 1,6-hexanediol dimethacrylate, 1,9-nonanediol dimethacrylate, 2-methyl-1,8-octanediol dimethacrylate, ethoxylated bisphenol A dimethacrylate, neopentyl glycol dimethacrylate, tricyclodecane dimethylol dimethacrylate, ethoxylated polypropylene glycol dimethacrylate, glycerine dimethacrylate, tripropylene glycol dimethacrylate, polypropylene glycol dimethacrylate, and the like; trifunctional acrylates such as ethoxylated trimethylol propane triacrylate, trimethylol propane triacrylate, propoxylated trimethylol propane triacrylate, pentaerythritol triacrylate, tris(acryloyloxyethyl) isocyanurate, and the like; trifunctional methacrylates such as trimethylolpropane trimethacrylate, ethoxylated trimethylolpropane trimethacrylate, and the like; acrylates having four or more acryloyl groups such as ethoxylated pentaerythritol tetraacrylate, di(trimethylolpropane) tetraacrylate, propoxylated pentaerythritol tetraacrylate, pentaerythritol tetraacrylate, dipentaerythritol hexaacrylate, and the like. Of the aforementioned (meth)acrylates, those having low shrinkage and ring structures are particularly useful as they serve to increase adhesion and/or strength of the resin layer. Examples of such (meth)acrylates include, for example, bis(acryloyloxyethyl) hydroxyethyl isocyanurate, tris(acryloyloxyethyl) isocyanurate, tricyclodecane dimethylol di(meth)acrylate, and the like.

Additionally, the (i) (meth)acrylate ingredient and the (ii) (meth)acrylate ingredient may be the same molecule. Specifically, a (meth)acrylate having one or more hydroxyl groups and two or more (meth)acryloyl groups in the molecule may be used as the ingredients (i) and (ii). Examples of such (meth)acrylates include, for example, compounds having two or more (meth)acryloyl groups such as trimethylpropane di(meth)acrylate, trimethylolethane (meth)acrylate, glycerine dimethacrylate, 2-hydroxy-3-(meth)acryloyloxypropyl (meth)acrylate, bis(acryloyloxyethyl)hydroxyethyl isocyanurate, and the like; compounds having three or more (meth)acryloyl groups such as tetramethylolmethane tri(meth)acrylate, and the like; compounds having four or more (meth)acryloyl groups such as dipentaerythritol penta(meth)acrylate, and the like.

The isocyanate groups in the molecule of the (iii) polyisocyanate having three or more isocyanate groups in the molecule react with the hydroxyl groups of the ingredient (i) at the time of thermal curing or over time to form urethane bonds. Additionally, the isocyanate groups may form trimerized isocyanurate bonds. Though not wishing to be bound by any theory, it is conceivable that the isocyanate groups of the ingredient (iii) will also react with functional groups (i.e. hydroxyl groups, carboxylic acid group, etc.) that may exist on the surfaces of the acrylic anti-abrasion coating layer to improve adhesion of the resin layer to the anti-abrasion coating layer.

Examples of such polyisocyanates include known polyisocyanate compounds for use as raw materials in urethane compounds such as, for example, aliphatic, cycloaliphatic, or aromatic polyisocyanate compounds. When used in optical applications, aliphatic or cycloaliphatic polyisocyanates are particularly useful.

Aliphatic polyisocyanate compounds generally include straight chain or branched chain saturated hydrocarbon groups having from 1 to 20 or 6 to 10 carbon atoms. The saturated hydrocarbon groups may be substituted with one, two, or more substituents. Examples of such substituents include, for example, groups having mono- or greater valency that are derived from isophorones, cyclohexanes, or the like. Specific examples of the aliphatic polyisocyanate compounds include 1,4,8-triisocyanatooctane, 1,6,11-triisocyanatoundecane, 1,8-diisocyanato-4-isocyanatomethyloctane, 1,3,6-triisocyanatohexane, 2,5,7-trimethyl-1,8-diisocyanato-5-isocyanatomethyloctane, and the like.

Cycloaliphatic polyisocyanate compounds generally include saturated or unsaturated cycloaliphatic hydrocarbon groups having from 3 to 20 or from 6 to 10 carbon atoms. Two or more cycloaliphatic hydrocarbon groups may be present and fused rings may be formed, or two or more cycloaliphatic hydrocarbon groups may exist and may be bonded together via a methylene group. The cycloaliphatic hydrocarbon groups may be substituted with one, two, or more substituents. Examples of such substituents include straight chain or branched chain alkyls having from 4 to 12 or from 6 to 10 carbon atoms, straight chain or branched chain alkylenes having from 4 to 12 carbon atoms, and the like. Specific examples of the cycloaliphatic polyisocyanate compounds include 1,3,5-triisocyanatocyclohexane, 1,3,5-tris(isocyanatomethyl)cyclohexane, 2-(3-isocyanatopropyl-2,5-di(isocyanatomethyl)bicyclo[2.2.1]heptane, 2-(3-isocyanatopropyl)-2,6-di(isocyanatomethyl)bicyclo[2.2.1]heptane, 3-(3-isocyanatopropyl)-2,5-di(isocyanatomethyl)bicyclo[2.2.1]heptane, 5-(2-isocyanatoethyl)-2-(isocyanatomethyl)-3-(3-(isocyanatopropyl)bicyclo[2.2.1]heptane, 6-(2-isocyanatoethyl)-2-(isocyanatomethyl)-3-(3-isocyanatopropyl)bicyclo[2.2.1]heptane, 5-(2-isocyanatoethyl)-2-(isocyanatomethyl)-2-(3-isocyanatopropyl)bicyclo[2.2.1]heptane, 6-(2-isocyanatoethyl)-2-(isocyanatomethyl)-2-(3-isocyanatopropyl)bicyclo[2.2.1]heptane, and the like.

Aromatic rings of the aromatic polyisocyanate compound are generally benzene or naphthalene. Two or more aromatic rings may be present, and, in these cases, the aromatic rings may be covalently bonded or bonded via a straight chain or branched chain alkylene or the like having from 2 to 20 or from 6 to 12 carbon atoms. The aromatic rings may be substituted with one, two, or more substituents. Examples of such substituents include, for example, straight chain or branched chain alkyls having from 2 to 20 or from 6 to 12 carbon atoms, straight chain or branched chain alkylenes having from 2 to 20 carbon atoms, and the like. Specific examples of the aromatic polyisocyanate compounds include triphenylmethane-4,4′,4′-triisocyanate, 1,3,5-triisocyanatobenzene, 2,4,6-triisocyanatotoluene, 4,4′-diphenylmethane-2,2′,5,5′-tetraisocyanate, 1,3,5-triisocyanatomethylbenzene, and the like.

Additionally, aliphatic, cycloaliphatic, or aromatic diisocyanate compounds and variants of the aforementioned aliphatic, cycloaliphatic, or aromatic polyisocyanate compounds such as, for example, biurets, isocyanurates, adducts obtained through an urethanization reaction of the polyhydroxy compounds, allophanates, oxadiazinetriones, uretdiones, and the like can be used as the polyisocyanate of the ingredient (iii). Among these, biurets and isocyanurates, especially biurets can be advantageously used because they express excellent adhesion of the resin layer to the acrylic anti-abrasion coating layer.

Aliphatic diisocyanate compounds that constitute the aforementioned variants generally include straight chain or branched chain saturated hydrocarbon groups having from 1 to 20 or 6 to 10 carbon atoms. The saturated hydrocarbon groups may be substituted with one, two, or more substituents. Examples of such substituents include, for example, groups having mono- or greater valency that are derived from isophorones, methylene biscyclohexanes, and the like; carboxyl groups; and the like. Specific examples of the aliphatic diisocyanate compounds include, for example, trimethylene diisocyanate, tetramethylene diisocyanate, pentamethylene diisocyanate, hexamethylene diisocyanate, 1,2-propylene diisocyanate, 1,2-butylene diisocyanate, 2,3-butylene diisocyanate, 1,3-butylene diisocyanate, 2,4,4- or 2,2,4-trimethyl hexamethylene diisocyanate, lysine diisocyanate, and the like.

Cycloaliphatic diisocyanate compounds that constitute the aforementioned variants generally include straight chain or branched chain saturated hydrocarbon groups having from 3 to 20 or 6 to 10 carbon atoms. Two or more cycloaliphatic hydrocarbon groups may be present, and, in these cases, the cycloaliphatic hydrocarbon groups may be bonded via a straight chain or branched chain alkylene or the like having from 1 to 12 or from 6 to 10 carbon atoms. The cycloaliphatic hydrocarbon groups may be substituted with one, two, or more substituents. Examples of such substituents include, for example, straight chain or branched chain alkyls having from 4 to 12 or from 6 to 10 carbon atoms, and the like. Specific examples of the cycloaliphatic diisocyanate compounds include, for example, 1,3-cyclopentane diisocyanate, 1,4-cyclohexane diisocyanate, 1,3-cyclohexane diisocyanate, 1,3-bis(isocyanatomethyl)-3,3,5-trimethylcyclohexane, 4,4′-methylene bis(cyclohexyl isocyanate), 2,4-cyclohexane diisocyanate, 1,3-bis(isocyanatomethyl) cyclohexane, 1,4-bis(isocyanatomethyl)cyclohexane, norbornane diisocyanate (also known as 2,5(2,6)-bis(isocyanatomethyl)bicyclo[2.2.1]heptane), isophorone diisocyanate, and the like.

Aromatic rings of the aromatic diisocyanate compounds that constitute the aforementioned variants are generally benzene or naphthalene. Two or more aromatic rings may be present, and, in these cases, the aromatic rings may be covalently bonded or bonded via a straight chain or branched chain alkylene or the like having from 1 to 20 or from 2 to 12 carbon atoms and oxygen atoms. The aromatic rings may be substituted with one, two, or more substituents. Examples of such substituents include, for example, straight chain or branched chain alkyl groups, amino groups, or the like having from 2 to 20 or from 6 to 12 carbon atoms. Specific examples of the aromatic diisocyanate compounds include, for example, m-phenylene diisocyanate, p-phenylene diisocyanate, 4,4′-biphenyl diisocyanate, 1,5-naphthalene diisocyanate, 4,4′-diphenylmethane diisocyanate, 2,4-tolylene diisocyanate, 2,6-tolylene diisocyanate, 4,4′-diphenylether diisocyanate, 1,3-xylylene diisocyanate, 1,4-xylylene diisocyanate, mixtures of 1,3-xylylene diisocyanate and 1,4-xylylene diisocyanate, ω,ω′-diisocyanato-1,4-diethylbenzene, 1,3-bis(1-isocyanato-1-methylethyl)benzene, 1,4-bis(1-isocyanato-1-methylethyl)benzene, mixtures of 1,3-bis(1-isocyanato-1-methylethyl)benzene and 1,4-bis(1-isocyanato-1-methylethyl)benzene, and the like.

Specific examples of the biurets include, for example, those shown in the following formula (I).

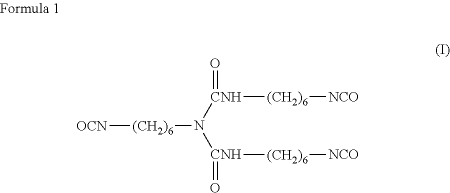

Specific examples of the isocyanurates include, for example, those shown in the following formula (II).

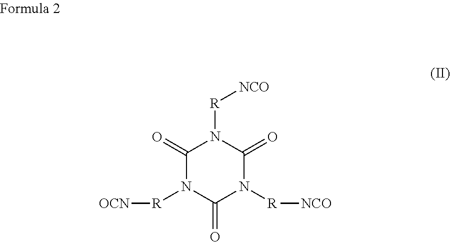

(wherein, R is an straight chain or branched chain alkyl having from 2 to 20 or from 2 to 10 carbon atoms, such as, for example, an ethyl, a butyl, or an hexyl group, or the like.)

The (v) silica nanoparticles (filler) can be fumed silica, colloidal silica, or amorphous silica. Conventional commercially available silicas that fall within the aforementioned silica nanoparticles (filler) range are Aerosil R-972 and Aerosil R-812 (commercially available from Degussa), IPA-ST, IPA-ST-L, IPA-ST-ZL, MEK-ST, MEK-ST-L, and MEK-ST-ZL (commercially available from Nissan Chemical), and CAB-O-SIL® TS-610 (commercially available from Cabot).

The resin layer includes 1 weight % or more or 5 weight % or more and 50 weight % or less or 20 weight % or less of the silica nanoparticles (filler), based on a weight of the reactive ingredients. A particle size of the silica nanoparticles (filler) is about 1 to 500 nm.

In order to improve dispersivity, silica nanoparticles (filler) that have been surface treated with a reactive silyl group such as dimethyldichlorosilane, hexamethyldisilazane, alkylsilane, methacryloxysilane, and the like, may be used.

Conventional compounds that induce radical polymerization reactions of (meth)acrylate can be used as the (iv) photoinitiator. Such photoinitiators include, for example, benzyl dimethyl ketal, 1-hydroxycyclohexyl phenyl ketone, 2-methyl-1-[4-(methylthio)phenyl]-2-morpholinopropan-1-one, 2-hydroxy-2-methyl-1-phenylpropan-1-one, 2-benzyl-2-dimethylamino-1-(4-morpholinophenyl)-butan-1-one, 1-[4-(2-hydroxyethoxy)-phenyl]-2-hydroxy-2-methyl-1-propan-1-one, bisacylphosphine oxide, acylphosphine oxide, 2,4,6-trimethylbenzoyl diphenylphosphine oxide, 2,6-dimethylbenzoyl diphenylphosphine oxide, benzoyl diethoxyphosphine oxide, bis(2,6-dimethoxybenzoyl)-2,4,4-trimethylpentyl phosphine oxide, benzoin alkyl ethers (i.e. benzoin methyl ether, benzoin ethyl ether, benzoin isopropylether, benzoin isobutylether, n-butyl benzoin ether, and the like), 1-(4-isopropylphenyl)-2-hydroxy-2-methylpropane-1-one, 2-hydroxy-2-methyl-1-phenylpropane-1-one, p-tert-butyl trichloroacetophenone, p-tert-butyl dichloroacetophenone, benzyl, benzoyl, acetophenone, benzophenone, thioxanthones (2-chlorothioxanthone, 2-methylthioxanthone, 2,4-diethylthioxanthone, 2,4-diisopropylthioxanthone), dibenzosuberone, 4,4′-dichlorobenzophenone, 4,4′-bis(dimethylamino)benzophenone, 4,4′-bis(diethylamino)benzophenone, 3,3′,4,4′-tetra(tert-butylperoxycarbonyl)benzophenone, benzalacetone, biacetyl, α,α-dichloro-4-phenoxy acetophenone, tetramethylthiuram disulfide, α,α′-azobisisobutyronitrile, benzoyl peroxide, 3,3′-dimethyl-4-methoxybenzophenone, methyl benzoyl formate, 2,2-diethoxy acetophenone, acyloxime ester, chlorinated acetophenone, hydroxyacetophenone, acetophenone diethyl ketal, 4′-isopropyl-2-hydroxy-2-methylpropiophenone, phenylglyoxylic acid methyl, methyl o-benzoylbenzoate, methyl p-dimethylaminobenzoate, 2,2′-bis(o-chlorophenyl)-4,5,4′,5′-tetraphenyl-1,2′-biimidazole, 10-butyl-2-chloroacridone, camphorquinone, 3-ketocoumarin, anthraquinones (i.e. anthraquinone, 2-ethylanthraquinone, α-chloroanthraquinone, 2-tert-butyl anthraquinone, and the like), acenaphthene, 4,4′-dimethoxybenzyl, 4,4′-dichlorobenzyl, and the like. These compounds may be used alone, in combinations of two or more, or in combination with a sensitizing agent. Conventionally, an amount of the photoinitiator used is based on a mass of the curable resin composition and is about 0.01 mass % or more or about 0.1 mass % or more and about 10 mass % or less or about 5 mass % or less.

As necessary, the curable resin composition may include a dilution monomer. The viscosity of the curable resin composition can be lowered by including the dilution monomer. In applications requiring solventless compositions, the dilution monomer can be used in place of a solvent. Various dilution monomers can be used so long as the physical properties of the resin layer after curing are not significantly compromised. Examples of such dilution monomers include, for example, styrene compounds such as styrene, alpha-methylstyrene, substituted styrene and the like; vinyl compounds such as vinyl ester, vinyl ether, N-vinyl-2-pyrrolidone, N-vinylcaprolactam, and the like; (meth)acrylamide compounds such as (meth)acrylamide, N-substituted (meth)acrylamide, and the like; (meth)acrylate compounds such as octyl (meth)acrylate, nonylphenolethoxylate (meth)acrylate, isononyl (meth)acrylate, isobornyl (meth)acrylate, dicyclopentanyl (meth)acrylate, dicyclopentenyl (meth)acrylate, 2-(2-ethoxy ethoxy)ethyl (meth)acrylate, 2-ethylhexyl (meth)acrylate, lauryl (meth)acrylate, β-carboxyethyl (meth)acrylate, isobutyl (meth)acrylate, isodecyl (meth)acrylate, dodedecyl (meth)acrylate, n-butyl (meth)acrylate, methyl (meth)acrylate, hexyl (meth)acrylate, stearyl (meth)acrylate, isooctyl (meth)acrylate, and the like; (meth)acrylonitrile; maleic anhydride, maleimide and derivatives thereof; itaconic acid, (meth)acrylic acid; combinations thereof; and the like. Among these, (meth)acrylate compounds can generally be used as their reactivity and other properties are similar to those of the other ingredients of the curable resin composition, and those having low shrinkage and ring structures are preferable as they increase adhesion and/or strength of the resin layer. Examples of such (meth)acrylate compounds include isobornyl (meth)acrylate, dicyclopentanyl (meth)acrylate, dicyclopentenyl (meth)acrylate, and the like.

As necessary, the curable resin composition may include a solvent. The solvent is preferably inert with respect to monomers, does not have a harmful effect on the reaction, and is easily removed from the resin layer. It is preferable that the solvent be a liquid at temperatures at which it is generally used. Examples of such solvents include, for example, ethyl acetate, butyl acetate, acetone, methyl ethyl ketone, methyl isobutyl ketone, methyl propyl ketone, methanol, ethanol, isopropanol, butanol, and the like.

As necessary, the curable resin composition may include further additives. Examples of the additives include, for example, organic fillers or inorganic fillers other than the silica nanoparticles (filler), antioxidants, thermal stabilizers, photostabilizers, anti-static agents, flame retardants, and combinations thereof. These additives can be compounded at amounts within ranges necessary to obtain the desired effects.

A hydroxyl group equivalent weight of the curable resin composition is based on a solid content mass of the curable resin composition minus the solvent, and is generally about 0.1 mol/kg or more, about 0.2 mol/kg or more, or about 0.3 mol/kg or more and about 5 mol/kg or less, about 3 mol/kg or less, or about 2 mol/kg or less. An isocyanate group equivalent weight of the curable resin composition is based on a solid content mass of the curable resin composition minus the solvent, and is generally about 0.02 mol/kg or more, about 0.05 mol/kg or more, or about 0.1 mol/kg or more and about 2.0 mol/kg or less, about 1.5 mol/kg or less, or about 1.0 mol/kg or less. A ratio of the isocyanate group equivalent weight to the hydroxyl group equivalent weight is generally about 0.05 equivalent weight or more, about 0.1 equivalent weight or more, or about 0.2 equivalent weight or more and about 5.0 equivalent weight or less, about 3.0 equivalent weight or less, or about 2.0 equivalent weight or less isocyanate group equivalent weight per one hydroxyl group equivalent weight. The resin layer can be thoroughly adhered to the acrylic anti-abrasion coating layer by setting the hydroxyl group equivalent weight, the isocyanate group equivalent weight, and the ratio thereof to the aforementioned values. Depending on the application, by using a composition in which the isocyanate groups do not greatly exceed the hydroxyl groups, suppression or prevention of the unreacted polyisocyanate compound becoming free from the resin layer and migrating to other areas, reacting with moisture during use and generating carbon dioxide (out gas), and yellowing of the resin layer due to amines produced by reactions with moisture are possible.

The curable resin composition is prepared by mixing ingredients (i) to (iv), as necessary and, (v) as desired. A mixing method may be selected as desired based on the amounts and properties of the ingredients to be mixed, for example, mechanical agitation, shaking, or the like.

In particular, a UV-curable monomer liquid mixture in which the silica nanoparticles (filler) are dispersed can be prepared by: first, sufficiently mixing (i) the (meth)acrylate having one or more hydroxyl groups in the molecule, (ii) the multi-functional (meth)acrylate having two or more (meth)acryloyl groups in the molecule, the diluent monomer, and (iv) the photoinitiator; then, adding (v) the silica nanoparticles (filler); and then adding (iii) the polyisocyanate after confirming that the silica nanoparticles (filler) have been sufficiently dispersed.

The multi-layer laminate can be produced using the curable resin composition obtained as discussed above. A manufacturing method for the multi-layer laminate includes the steps of: preparing a substrate having an acrylic anti-abrasion coating layer on at least one surface; preparing a curable resin composition including: (i) a (meth)acrylate having one or more hydroxyl groups in the molecule, (ii) a multi-functional (meth)acrylate having two or more (meth)acryloyl groups in the molecule, (iii) a polyisocyanate having three or more isocyanate groups in the molecule, and (iv) a photoinitiator, or the curable resin composition further including (v) silica nanoparticles (filler); applying the curable resin composition on the acrylic anti-abrasion coating layer; radiation curing the curable resin composition; and thermal curing the curable resin composition.

In the step of applying the curable resin composition on the acrylic anti-abrasion coating layer and the steps prior thereto, unreacted (meth)acryloyl groups contained in the ingredients (i) and (ii), unreacted hydroxy groups contained in the ingredient (i), and unreacted isocyanate groups contained in the ingredient (iii) are present in the curable resin composition. In the step of radiation curing the curable resin composition, the photoinitiator will generate radicals due to the radiation curing, and, as a result, the (meth)acryloyl groups will polymerize, and an at least partially cured resin layer will form. In the step of thermal curing the curable resin composition, the hydroxyl groups and the isocyanate groups will react and form urethane bonds, and, simultaneously, the resin layer will adhere to the acrylic anti-abrasion coating layer. Thus, by radiation curing and thermal curing the curable resin composition that is on the acrylic anti-abrasion coating layer, a polymerization product of the curable resin composition is obtained, and a state is formed in which the resin layer including this polymerization product that is on the acrylic anti-abrasion coating layer is adhered to the anti-abrasion coating layer. When the (v) silica nanoparticles (filler) are included in the curable resin composition, since the particle size is of the nano order, clarity of the resin layer can be maintained, and a surface hardness thereof of pencil hardness 3H or harder is obtainable.

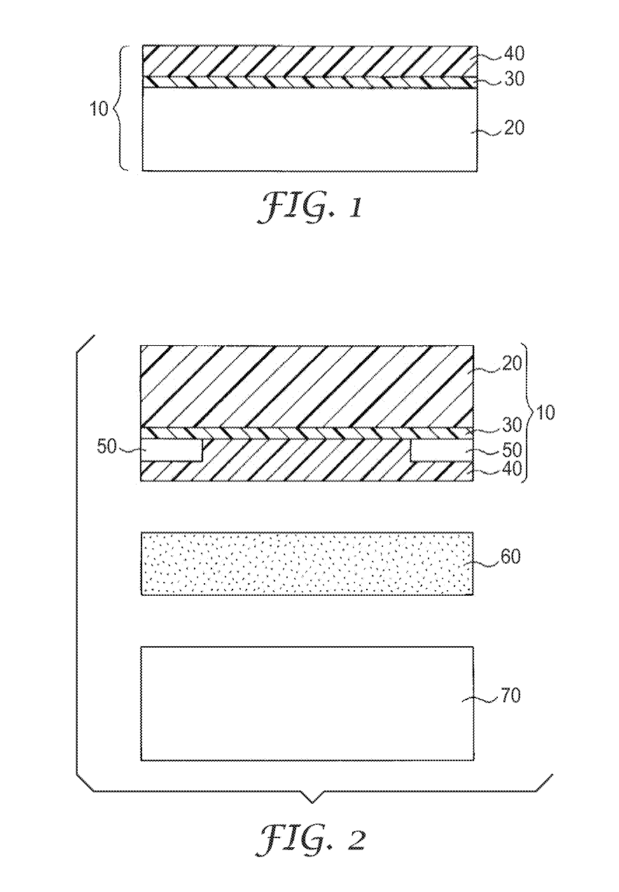

A cross sectional view of an embodiment of a multi-layer laminate produced in this way is shown in FIG. 1. A multi-layer laminate 10 is provided with an acrylic anti-abrasion coating layer 30 on a substrate 20, and a resin layer 40, formed from the cuarable resin composition, is adhered on the acrylic anti-abrasion coating layer 30.

The curable resin composition can be applied to the acrylic anti-abrasion coating layer of the substrate using known methods including, for example, casting, bar coating, screen printing, spincoating, and the like. Generally, a UV lamp having a spectral distribution in a wavelength range of from 200 to 400 nm is used for the radiation curing. Examples of such UV lamps include, for example, low-pressure mercury lamps, high-pressure mercury lamps, ultra-high pressure mercury lamps, metal halide lamps, microwave-induced mercury lamps, and the like. Electron beams may also be used to perform the radiation curing. A person skilled in the art may adjust irradiation conditions as necessary, taking into account the ingredients, compounded amounts, and applied amount (coating thickness) of the curable resin composition. The radiation curing may be performed under an inert atmosphere (i.e. nitrogen, argon, etc.) for the purpose of promoting radical polymerization. The thermal curing, taking into account the heat resistance of the substrate, is generally performed at about 20° C. or higher or about 40° C. or higher, and about 90° C. or lower or about 120° C. or lower. A duration of the thermal curing is generally about 1 hour or more or about 12 hours or more, and is about 2 days or less or 5 days or less, but may be performed over the course of 1 week or more. The heat curing may be done before and/or after the radiation curing, and by setting an atmospheric temperature at a time of radiation curing to the aforementioned heat curing temperature, the radiation curing and the heat curing may be performed simultaneously. A thickness of the resin layer formed in this way is generally about 2 μm or more or about 10 μm or more, and about 50 μm or less or about 100 μm or less.

For example, in cases when the reaction that forms the urethane bonds does not proceed sufficiently due to properties of the raw materials, a catalyst for promoting the reaction may be used. When forming urethane bonds at low temperatures, such catalysts can be used effectively. Examples of suitable catalysts include, for example, organotin compounds such as dibutyltin laurate, dibutyltin octate, dibutyltin dimethoxide, and the like; amine compounds such as triethylamine, diethanolamine, dimethylbutyl ethanolamine, and the like; and the like. Other than these, titanium compounds, aluminum compounds, zirconium compounds, and the like can also be used. An amount of the catalyst used can be adjusted as necessary according to the types and amounts of the raw materials, but generally are based on a mass of the curable resin composition and are about 0.01 mass % or more or about 0.1 mass % or more, and about 2.5 mass % or less or about 1.5 mass % or less.

A number of specific examples of applications of the multi-layer laminate of the present disclosure are hereafter described, but applications of the present invention are not limited thereto.

A multi-layer laminate according to an embodiment of the present disclosure can be used advantageously as a protective film for an image display device such as an LCD or an optical member such as a touch panel that can fill uneven surfaces between a printed portion (i.e. a border pattern around an image display region) and a non-printed portion and can equalize stress on an adhesive layer. Such a protective film and image display device or optical member are shown in FIG. 2 as simplified cross sectional views. A protective film 10 is formed from a plastic film substrate 20 such as a (meth)acrylic resin or polycarbonate provided with an anti-abrasion coating layer 30 and, for example, a printing layer 50 including a black pigment or the like is partially provided around an image display region. If the printing layer is black, a thickness of the printing layer 50 is generally about from 5 to 30 μm, for example, about 10 μm, and if the printing layer is white the thickness may be 50 μm or more. The printing layer is provided for the purposes of, for example, decoration and/or blocking transmitted light. In the drawings, for clarity of disclosure, an anti-abrasion coating layer on the surface opposite the surface of the plastic film substrate 20 on which the resin layer 40 is provided is omitted, but with the protective film 10, an anti-abrasion coating layer is generally provided on this surface as well.

The protective film 10 is manufactured by applying the curable resin composition according to the present disclosure on the anti-abrasion coating layer 30 so as to simultaneously cover the printing layer 50, leveling the applied composition using a flat glass plate or the like, and then radiation curing and thermal curing the composition according to the aforementioned methods to form the resin layer 40. The resin layer 40 is excellently adhered to the anti-abrasion coating layer 30 and will not easily peel off from the anti-abrasion coating layer 30 even in regions prone to stress concentration such as, for example, boundary regions between printed portions and non-printed portions or regions that have been subjected to processing such as drilling, machining, cutting, or the like and surrounding regions thereof. By adhering the protective film 10 to an image display device such as an LCD or an optical member such as a touch panel 70 via an adhesive layer 60 made from a thermal curable adhesive, a hot-melt adhesive, a two-pack adhesive, a pressure-sensitive adhesive, or the like, a surface of the image display device or optical member 70 can be protected. As uneven surfaces between the printed portions (printing layer 50) and the non-printed portions are filled by the resin layer 40, the adhesive layer 60 can be uniformly applied to the protective film 10. When using the protective film 10 on the image display device 70 such as an LCD, stress on the adhesive layer 60 is equalized across the entire image display region. Therefore, occurrences of color non-uniformity in the image display region can be prevented or reduced. When using the protective film 10 on the optical member 70 such as a touch panel, as described previously, unevenness of the surface of the protective film 10 can be eliminated. Therefore, the protective film 10 can be applied neatly to the optical member 70 without any defects such as air bubble contamination.

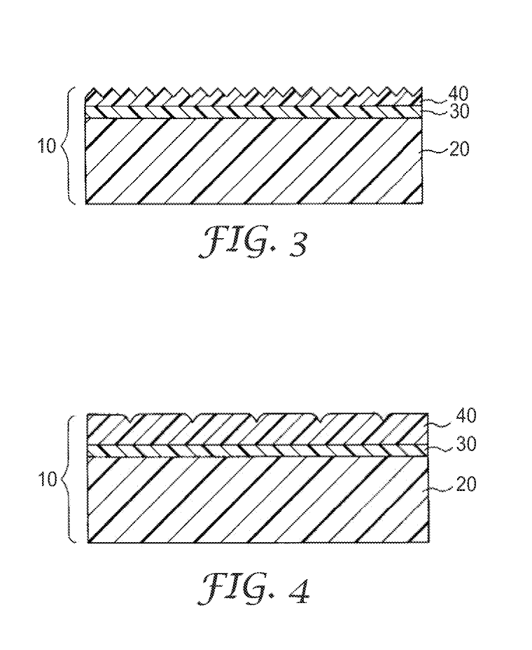

A multi-layer laminate according to another embodiment of the present disclosure can be used in applications such as camera lenses and optical device pick-up lenses as a structure having anti-reflective function formed from a substrate such as a glass or plastic lens or plate having an anti-abrasion coating layer and a resin layer having fine surface structures provided on a surface of the substrate. A cross sectional view of such a structure 10 is shown in FIG. 3. An anti-abrasion coating layer 30 is provided on a substrate 20 having an arbitrary surface configuration (i.e. flat surface or curved surface), and a resin layer 40 having fine surface structures is formed on the anti-abrasion coating layer 30. The fine surface structures are a line of multiple structures on a surface of the substrate 20 such as, for example, wedge-shaped, circular cone-shaped, or pyramid-shaped structures. A size of these structures is smaller than a wavelength of light, for example, that of visible light (from 350 nm to 800 nm), for which they are intended. When light having a wavelength larger than the structures enters the fine surface structures, said light enters the substrate 20 with only minor reflection in cases of both normal incidence and oblique incidence.

Such fine surface structures can be formed by, for example, applying the curable resin composition to the anti-abrasion coating layer 30 of the substrate 20, pressing a mold having an inverted pattern of the fine surface structures onto the curable resin composition, and curing the curable resin composition in such state to transfer the pattern of the mold to a surface of the resin layer 40 (also called “nano imprinting”).

A multi-layer laminate according to another embodiment of the present disclosure can be used in instrument panels, display panels, and the like of vehicles, electric/electronic devices, and the like as a resin sheet having a fine decorative pattern such as that described in PCT International Publication No. WO2006/112044. A cross sectional view of such a resin sheet 10 is shown in FIG. 4. A resin layer 40 having fine grooves is formed on an anti-abrasion coating layer 30 of a transparent substrate 20 made from (meth)acrylic resin, polycarbonate, polyester, or the like. These fine grooves form a part of the fine decorative pattern. Though not shown in the drawings, patterns such as letters, numbers, and the like may be printed on the substrate 20 or the resin layer 40 or between the anti-abrasion coating layer 30 and the resin layer 40, transparent printing may be conducted on the resin layer 40 using a mirror ink, or a metal film may be deposited on the substrate 20.

Such a resin sheet 10 can be formed by, for example, applying the curable resin composition to the anti-abrasion coating layer 30 of the substrate 20; pressing a metal plate (i.e. an aluminum plate, a copper plate, a stainless steel plate, or the like), on a surface of which an inverted pattern of the fine decorative pattern is formed by hairline processing, for example, onto the curable resin composition; and curing the curable resin composition by radiation curing from the transparent substrate 20 side to transfer the pattern of the metal plate to a surface of the resin layer 40.

The present invention is described in detail below by referring to Examples, but the scope of the present invention is not limited by these Examples.

### EXAMPLES

(I) Raw materials included in the curable resin composition are shown below.

Aronix® M-313 (Toagosei Co., Ltd.): Mixture of bis(acryloyloxyethyl) hydroxyethyl isocyanurate and tris(acryloyloxyethyl)isocyanurate. A content percentage of the bis(acryloyloxyethyl)hydroxyethyl isocyanurate therein is from 30 to 40 mass % (values taken from catalog).

KAYARAD R-684 (Nippon Kayaku Co., Ltd.): Tricyclodecane dimethanol diacrylate

TMPTA: Trimethylol propane triacrylate (LIGHT-ACRYLATE® TMP-A (Kyoeisha Chemical Co., Ltd.))

D-TMPTA: Di(trimethylolpropane) tetraacrylate (NK Ester AD-TMP (Shin-Nakamura Chemical Co., Ltd.))

DPHA: Dipentaerythritol hexaacrylate (NK Ester A-DPH (Shin-Nakamura Chemical Co., Ltd.))

Duranate™ 22A-100 (Asahi Kasei Chemicals Corporation): Hexamethylene diisocyanate derived polyisocyanate, biuret, isocyanate content percentage=22.0 mass %

Duranate™ 24A-100 (Asahi Kasei Chemicals Corporation): Hexamethylene diisocyanate derived polyisocyanate, biuret, isocyanate content percentage=23.5 mass %

Duranate™ TPA-100 (Asahi Kasei Chemicals Corporation): Hexamethylene diisocyanate derived polyisocyanate, isocyanurate, isocyanate content percentage=23.1 mass %

Duranate™ TSE-100 (Asahi Kasei Chemicals Corporation): Hexamethylene diisocyanate derived polyisocyanate, isocyanurate, isocyanate content percentage=12.0 mass %

Duranate™ D201 (Asahi Kasei Chemicals Corporation): Isocyanate of a bifunctional prepolymer, isocyanate content percentage=15.8 mass %

IRGACURE 907 (Chiba•Japan Co., Ltd.): Photoinitiator

HEA: 2-hydroxyethyl acrylate (Osaka Organic Chemical Industry, Ltd.)

IBXA: Isobornyl acrylate (Kyoeisha Chemical Co., Ltd.)

Shikoh® UV-7600B (Nippon Synthetic Chemical Industry Co., Ltd.): Urethane acrylate

EBECRYL 4858 (DAICEL-CYTEC Co. Ltd.): Urethane acrylate

AEROSIL™ R972 (manufactured by Nippon Aerosil Co., Ltd.)

CAB-O-SIL™ TS-6108 (manufactured by Cabot Specialty Chemicals Inc.)

(III) Acrylic resin sheets and polycarbonate composite plates used in evaluation as the substrate having an anti-abrasion coating layer are shown in Table 1.

(IV) Data measurement and evaluation methods are shown below.

### Adhesion Test

Adhesion of the resin layer (cured film) formed by applying a curable resin composition to a surface of a substrate having an anti-abrasion coating layer was evaluated as follows in general accordance with JIS K5600-5-6 (1999). A utility knife was used to make 25 squares spaced 1 mm apart on the substrate on which the resin layer is formed on the surface of the anti-abrasion coating layer and an adhesive tape (Mending Tape 810, manufactured by Sumitomo 3M Limited) was applied at room temperature. Then, the tape was quickly peeled from the substrate at an angle of approximately 60° and a condition of the squares was examined. Adhesion was evaluated as follows.

A (Very good adhesion): The resin layer remained on 25 squares (no peeling)

B (Good adhesion): The resin layer remained on 23 to 24 squares

NG (Poor adhesion): 3 squares or more displayed peeling

Scratch hardness (pencil hardness) of the acrylic resin sheet and polycarbonate compound plate on which a cured film is formed was evaluated in accordance with JIS K 5600-5-4.

### Evaluation of Haze Value and Transmission

A haze value and transmission of the acrylic resin sheet on which a cured film is formed was measured using the NDH2000 (manufactured by Nippon Denshoku Industries Co., Ltd.), which is in accordance with JIS K7136 (ISO14782) and JISK7361-1 (ISO13468-1).

### Measurement of Solution Viscosity

A viscosity of the solution was measured at room temperature using a Brookfield rotational viscometer. Measurement conditions were as follows.

Type: B (BM model, Toki Sangyo Co., Ltd.)

Rotor number: No. 2

Rotating speed: 30 rpm

(V) Test samples were prepared according to the following method.

### Examples 1 to 11 and Comparative Examples 1 to 11

### Preparation of Curable Resin Composition-1 (Preparation of a Curable Resin Composition that does not Contain Silica Nanoparticles (Filler))

Following the left column of Table 2a, a curable resin composition was prepared by thoroughly mixing a raw material containing an acrylate having one or more hydroxyl groups in the molecule (A1, A2; A2 also functions as a dilution monomer), a multi-functional acrylate having two or more acryloyl groups in the molecule (B1, B2), a dilution monomer as an optional ingredient (C), a polyisocyanate having three or more isocyanate groups in the molecule (D), and a photoinitiator (E). In the tables, all numerical values related to the composition, unless otherwise stated, are expressed in parts by mass.

### Application of the Substrate Having an Anti-Abrasion Coating Layer

An ACRYLITE® MR-200 (manufactured by Mitsubishi Rayon Co., Ltd.) acrylic resin sheet (40 mm×60 mm, thickness=0.8 mm) was used as the substrate having an anti-abrasion coating layer. Adhesive tape (Tomei Bishoku®, manufactured by Sumitomo 3M Limited) having a width of about 2 mm was applied to a short edge of this sheet as a spacer. A thickness of this adhesive tape was about 50 micrometers. The curable resin composition according to Table 2a was coated on this sheet, and then a float glass (55 mm×100 mm, thickness=2.0 mm) was pressed down on it. After the solution was spread sufficiently, it was cured by UV light irradiation using the F-300 UV-light irradiation device (D-bulb, 120 W/cm; manufactured by Fusion UV Systems Japan KK). The curing conditions were set to 60 m/min×20 passes. The amount of UV energy of UVA per one pass at the time of irradiation as measured by the UV Power Puck® II actinometer (manufactured by EIT, Inc.) was 86 mJ/cm². Next, by removing the float glass, an acrylic resin sheet constituted by a UV cured composition (resin layer) having a smooth surface being formed on an anti-abrasion coating layer was obtained.

Next, this sheet was left in an oven at 60° C. for three days to heat cure.

The adhesion of the resin layer and scratch hardness were then evaluated for the obtained sheet as described above. Results of the evaluations are shown in the right columns of Table 2b.

### Examples 12 to 15 and Comparative Examples 12 to 15

Other than the acrylic resin sheets or polycarbonate conjugate plates shown in Table 3 being used in place of ACRYLITE® MR-200 as the substrate having an anti-abrasion coating layer, curable resin compositions identical to those used in Example 1 and Comparative Example 1 were used for Examples 12 to 15 and Comparative Examples 12 to 15, respectively. The right column of Table 3 shows evaluation results for these Examples and Comparative Examples together with the evaluation results of

### Example 1 and Comparative Example 1

### Comparative Examples 16 to 17

Other than using a monomer already having urethane bonds, specifically urethane acrylate (F), in place of forming urethane bonds through heat curing from the hydroxyl groups and isocyanate groups contained in the curable resin composition on the acrylic resin sheet having an anti-abrasion coating layer, Comparative Examples 16 and 17 were conducted the same as Example 1. Evaluation results are shown in the right columns of Table 4.

### Comparative Example 18

Duranate™ 24A-100 (Asahi Kasei Chemicals Corporation), a polyisocyanate compound, was prepared using a mixed solvent of toluene and methyl ethyl ketone (MEK) (toluene/MEK=50 mass %/50 mass %) so that it was 3 mass %. After coating this coating solution on the ACRYLITE® MR-200 using a Rod No. 4 bar coater (manufactured by Nippon Seadus Service), the solvent was dried.

Then, the curable resin composition of Comparative Example 3 (no polyisocyanate added) was coated on the acrylic resin sheet that was coated with the polyisocyanate and UV cured and heat cured. Evaluation results are shown in the right column of Table 5.

### Examples 16 to 22 and Comparative Examples 19 to 20

### Preparation of Curable Resin Composition-2 (Preparation of a Curable Resin Composition that Contains Silica Nanoparticles (Filler))

Following the left columns of Tables 6a, 7a and 8a, a curable resin composition was prepared by thoroughly mixing a raw material containing an acrylate having one or more hydroxyl groups in the molecule (A1, A2; A2 also functions as a dilution monomer), a multi-functional acrylate having two or more acryloyl groups in the molecule (B1, B2), a dilution monomer as an optional ingredient (C), silica nanoparticles (filler) (F), and a photoinitiator (E), and thereafter lastly adding a polyisocyanate having three or more isocyanate groups in the molecule (D), and thoroughly mixing again. In the tables, all numerical values related to the composition, unless otherwise stated, are expressed in parts by mass. Evaluation results are shown in the right columns of Tables 6b, 7b and 8b.

TABLE 1

| | | Scratch | |
|---|---|---|---|
| Substrates | Supplier | Hardness^{a)} | Properties^{a)} |
| ACRYLITE ® | Mitsubishi | 6-7H | Scratch Resistance |
| MR-200 | Rayon Co., | | |
| | Ltd. | | |
| SUMIPEX ® | Sumitomo | 5H | Scratch Resistance |
| E MR | Chemical | | |
| | Co., Ltd. | | |
| SUMIELEC ® | Sumitomo | 4H | Scratch Resistance |
| II | Chemical | | Antistatic Performance |
| | Co., Ltd. | | |
| Delaglas ™ | Asahi | 4H | Scratch Resistance |
| HAS | Kasei | | Antistatic Performance |
| | Corporation | | |
| SUMIELEC ® | Sumitomo | 4H | Scratch Resistance Coating |
| CW06 | Chemical | | Methacryl resin/polycarbonate |
| | Co., Ltd. | | composite plate anti-abrasion |
| | | | coating/PMMA/PC/PMMA/ |
| | | | anti-abrasion coating |

^{a)}Supplier data sheet

TABLE 2a

| | Formulations | | | | | | | | | | | | |
|---|---|---|---|---|---|---|---|---|---|---|---|---|---|
| | A1 | A2 | B1 | B2 | | | C | D | | | | | E |
| Material | M-313 | HEA | R-684 | TMPTA | D-TMPTA | DPHA | IBXA | 24A-100 | 22A-100 | TPA-100 | TSE-100 | D-201 | Irg907 |
| Ex. 1 | 40 | — | 60 | — | — | — | — | 2.4 | — | — | — | — | 0.5 |
| Ex. 2 | 40 | — | 60 | — | — | — | — | — | 2.4 | — | — | — | 0.5 |
| Ex. 3 | 40 | — | 60 | — | — | — | — | — | — | 2.4 | — | — | 0.5 |
| Ex. 4 | 40 | — | 60 | — | — | — | — | — | — | — | 4.8 | — | 0.5 |
| Ex. 5 | 36.4 | 9.1 | 54.5 | — | — | — | — | 2.4 | — | — | — | — | 0.5 |
| Ex. 6 | 33.3 | 16.7 | 50 | — | — | — | — | 2.4 | — | — | — | — | 0.5 |
| Ex. 7 | 36.4 | — | 54.5 | — | — | — | 9.1 | 2.4 | — | — | — | — | 0.5 |
| Com. Ex. 1 | 40 | — | 60 | — | — | — | — | — | — | — | — | — | 0.5 |
| Com. Ex. 2 | 40 | — | 60 | — | — | — | — | — | — | — | — | 3.6 | 0.5 |
| Com. Ex. 3 | 36.4 | 9.1 | 54.5 | — | — | — | — | — | — | — | — | — | 0.5 |
| Com. Ex. 4 | 36.4 | — | 54.5 | — | — | — | 9.1 | — | — | — | — | — | 0.5 |
| Ex. 8 | — | 9.1 | 60 | 36.4 | — | — | — | 2.4 | — | — | — | — | 0.5 |
| Com. Ex. 5 | — | — | 60 | 40 | — | — | — | — | — | — | — | — | 0.5 |
| Com. Ex. 6 | — | — | 60 | 40 | — | — | — | 2.4 | — | — | — | — | 0.5 |
| Com. Ex. 7 | — | 9.1 | 60 | 36.4 | — | — | — | — | — | — | — | — | 0.5 |
| Ex. 9 | — | 9.1 | 60 | — | 36.4 | — | — | 2.4 | — | — | — | — | 0.5 |
| Com. Ex. 8 | — | — | 60 | — | 40 | — | — | — | — | — | — | — | 0.5 |
| Com. Ex. 9 | — | — | 60 | — | 40 | — | — | 2.4 | — | — | — | — | 0.5 |
| Ex. 10 | — | 18.2 | 36.3 | — | — | 36.4 | 9.1 | 4.8 | — | — | — | — | 0.5 |
| Com. Ex. 10 | — | — | 60 | — | — | 40 | — | — | — | — | — | — | 0.5 |
| Com. Ex. 11 | — | — | 60 | — | — | 40 | — | 4.8 | — | — | — | — | 0.5 |
| Ex. 11 | 30 | 10 | — | — | 40 | — | 20 | 4.8 | — | — | — | — | 0.5 |

TABLE 2b

| | | | | Adhesion | | |
|---|---|---|---|---|---|---|
| | OH volume^{a)} | NCO volume | NCO/OH | Before heat | After heat | Viscosity^{b)} |
| | (mol/kg) | (mol/kg) | (mol/mol) | curing | curing | (mPa · s) |
| Ex. 1 | ca. 0.32 | ca. 0.13 | ca. 0.4 | NG | A | 730 |
| Ex. 2 | ca. 0.32 | ca. 0.12 | ca. 0.4 | NG | A | N.A. |
| Ex. 3 | ca. 0.32 | ca. 0.13 | ca. 0.4 | NG | B | N.A. |
| Ex. 4 | ca. 0.31 | ca. 0.13 | ca. 0.4 | NG | B | N.A. |
| Ex. 5 | ca. 1.0 | ca. 0.13 | ca. 0.1 | NG | A | 260 |
| Ex. 6 | ca. 1.7 | ca. 0.13 | ca. 0.08 | NG | A | 130 |
| Ex. 7 | ca. 0.29 | ca. 0.13 | ca. 0.4 | NG | A | 430 |
| Com. Ex. 1 | ca. 0.32 | N.A. | N.A. | NG | NG | N.A. |
| Com. Ex. 2 | ca. 0.31 | ca. 0.13 | ca. 0.4 | NG | NG | N.A. |
| Com. Ex. 3 | ca. 1.1 | N.A. | N.A. | NG | NG | 245 |
| Com. Ex. 4 | ca. 0.29 | N.A. | N.A. | NG | NG | 400 |
| Ex. 8 | ca. 0.76 | ca. 0.13 | ca. 0.2 | NG | A | N.A. |
| Com. Ex. 5 | N.A. | N.A. | N.A. | NG | NG | N.A. |
| Com. Ex. 6 | N.A. | ca. 0.13 | N.A. | NG | NG | N.A. |
| Com. Ex. 7 | ca. 0.78 | N.A. | N.A. | NG | NG | N.A. |
| Ex. 9 | ca. 0.76 | ca. 0.13 | ca. 0.2 | NG | A | N.A. |
| Com. Ex. 8 | N.A. | N.A. | N.A. | NG | NG | N.A. |
| Com. Ex. 9 | N.A. | ca. 0.13 | N.A. | NG | NG | N.A. |
| Ex. 10 | ca. 1.5 | ca. 0.25 | ca. 0.2 | NG | A | N.A. |
| Com. Ex. 10 | N.A. | N.A. | N.A. | NG | NG | N.A. |
| Com. Ex. 11 | N.A. | ca. 0.25 | N.A. | NG | NG | N.A. |
| Ex. 11 | ca. 1.1 | ca. 0.25 | ca. 0.2 | NG | A | N.A. |

^{a)}Calculated as bis(acryloyloxyethyl) hydroxyethyl isocyanurate/tris(acryloyloxyethyl) isocyanurate = 30 mass %/70 mass %
^{b)}“N.A.” means that no measurement was taken or that there was not a numerical value that applied.

TABLE 3

| | | | Adhesion |
|---|---|---|---|
| | | | (After heat |
| | Substrates | Polyisocyanate | curing) |
| Example 1 | ACRYLITE ® MR-200 | Added | A |
| Comparative | | Not added | NG |
| Example 1 | | | |
| Example 12 | SUMIPEX ® E MR | Added | A |
| Comparative | | Not added | NG |
| Example 12 | | | |
| Example 13 | SUMIELEC ® II | Added | A |
| Comparative | | Not added | NG |
| Example 13 | | | |
| Example 14 | Delaglas ™ HAS | Added | A |
| Comparative | | Not added | NG |
| Example 14 | | | |
| Example 15 | SUMIELEC ® CW06 | Added | A |
| Comparative | | Not added | NG |
| Example 15 | | | |

TABLE 4

| | | | | | | | | Adhesion | |
|---|---|---|---|---|---|---|---|---|---|
| | Material/Formulation (top/bottom) | | | | | | | Before heat | After heat |
| | A1 | A2 | B1 | C | D | E | F | curing | curing |
| Comparative | M-313 | — | R-684 | — | — | Irg907 | UV-7600B | NG | NG |
| Example 16 | 40 | | 60 | | | 0.6 | 24 | | |
| Comparative | M-313 | — | R-684 | — | — | Irg907 | EBECRYL 4858 | NG | NG |
| Example 17 | 40 | | 60 | | | 0.6 | 24 | | |

TABLE 5

| | | | | | | | Adhesion |
|---|---|---|---|---|---|---|---|
| | Material/Formulation (top/bottom) | | | | | | (After heat |
| | A1 | A2 | B1 | C | D | E | curing) |
| Comparative | M-313 | HEA | R-684 | — | — | Irg907 | NG |
| Example 18 | 36.4 | 9.1 | 54.5 | | | 0.5 | |

TABLE 6a

| | Materials | | | | | |
|---|---|---|---|---|---|---|
| | A-1 | B-1 | C | D | E | F |
| | Monomer Mixture | | | | | |
| | | | | | AEROSIL ® | Duranate ™ |
| | M-313 | R-684 | IBXA | Irg907 | R 972 | 22A-100 |
| Example 16 | 40 | 60 | 10 | 2 | 0 | 3 |
| Example 17 | 40 | 60 | 10 | 2 | 10 | 3 |
| Example 18 | 40 | 60 | 10 | 2 | 15 | 3 |
| Example 19 | 40 | 60 | 10 | 2 | 20 | 3 |
| Comparative | 40 | 60 | 10 | 2 | 0 | 0 |
| Example 19 | | | | | | |
| Comparative | 40 | 60 | 10 | 2 | 20 | 0 |
| Example 20 | | | | | | |

TABLE 6b

| | | | | Results | | | |
|---|---|---|---|---|---|---|---|
| | OH volume^{a)} | NCO volume | NCO/OH | | Pencil | | Transmittance |
| | (mol/kg) | (mol/kg) | (mol/mol) | Adhesion^{b)} | Hardness | Haze | (%) |
| Example 16 | ca. 0.28 | ca. 0.15 | ca. 0.53 | A | 2H-3H | 0.23 | 91.61 |
| Example 17 | ca. 0.26 | ca. 0.14 | ca. 0.53 | A | 3H | 0.84 | 91.1 |
| Example 18 | ca. 0.25 | ca. 0.13 | ca. 0.53 | A | 3H | 0.95 | 90.73 |
| Example 19 | ca. 0.24 | ca. 0.13 | ca. 0.53 | A | 4H | 1.18 | 89.93 |
| Comparative | ca. 0.29 | N.A. | N.A. | C | N.A. | 0.24 | 91.85 |
| Example 19 | | | | | | | |
| Comparative | ca. 0.24 | N.A. | N.A. | C | N.A. | 1.06 | 90.2 |
| Example 20 | | | | | | | |

^{a)}Calculated as bis(acryloyloxyethyl) hydroxyethyl isocyanurate/tris(acryloyloxyethyl) isocyanurate = 30 mass %/70 mass %
^{b)}“Adhesion” refers to data measured after heat curing.

TABLE 7a

| | Materials | | | | | |
|---|---|---|---|---|---|---|
| | A-1 | B-1 | C | D | E | F |
| | Monomer Mixture | | | | | |
| | | | | | AEROSIL ® | Duranate ™ |
| | M-313 | R-684 | IBXA | Irg907 | R 972 | 22A-100 |
| Example 20 | 40 | 60 | 15 | 2 | 20 | 6 |

TABLE 7b

| | | | | Results | | | |
|---|---|---|---|---|---|---|---|
| | OH volume^{a)} | NCO volume | NCO/OH | | Pencil | | Transmittance |
| | (mol/kg) | (mol/kg) | (mol/mol) | Adhesion ^{b)} | Hardness | Haze | (%) |
| Example 20 | ca. 0.22 | ca. 0.26 | ca. 1.2 | A | 4H | 1.60 | 89.39 |

^{a)}Calculated as bis(acryloyloxyethyl) hydroxyethyl isocyanurate/tris(acryloyloxyethyl) isocyanurate = 30 mass %/70 mass %
^{b)} “Adhesion” refers to data measured after heat curing.

TABLE 8a

| | Materials | | | | | |
|---|---|---|---|---|---|---|
| | A-1 | B-1 | C | D | E | F |
| | Monomer Mixture | | | | | |
| | | | | | AEROSIL ® | Duranate ™ |
| | M-313 | R-684 | IBXA | Irg907 | R 972 | 22A-100 |
| Example 21 | 40 | 60 | 10 | 2 | 20 | 3 |
| Example 22 | 40 | 60 | 10 | 2 | 25 | 6 |

TABLE 8b

| | | | | Results | | | |
|---|---|---|---|---|---|---|---|
| | OH volume^{a)} | NCO volume | NCO/OH | | Pencil | | Transmittance |
| | (mol/kg) | (mol/kg) | (mol/mol) | Adhesion^{b)} | Hardness | Haze | (%) |
| Example 21 | ca. 0.24 | ca. 0.13 | ca. 0.56 | A | 4H | 2.49 | 89.72 |
| Example 22 | ca. 0.22 | ca. 0.25 | ca. 1.1 | A | 4H | 4.36 | 88.22 |

^{a)}Calculated as bis(acryloyloxyethyl) hydroxyethyl isocyanurate/tris(acryloyloxyethyl) isocyanurate = 30 mass %/70 mass %
^{b)}“Adhesion” refers to data measured after heat curing.

1. A multi-layer laminate comprising:
a substrate having an acrylic anti-abrasion coating layer on at least one surface; and
a resin layer formed on the acrylic anti-abrasion coating layer; wherein
the resin layer comprises a polymerization product of a curable resin composition including:
(i) a (meth)acrylate having one or more hydroxyl groups in the molecule;
(ii) a (meth)acrylate having two or more (meth)acryloyl groups in the molecule;
(iii) a polyisocyanate having three or more isocyanate groups in the molecule; and
(iv) a photoinitiator.

2. The multi-layer laminate according to claim 1, wherein the resin layer further comprises (v) silica nanoparticles as a filler.

3. The multi-layer laminate according to claim 1, wherein the substrate comprises a (meth)acrylic resin layer and/or a polycarbonate layer.

4. The multi-layer laminate according to claim 1, wherein the polyisocyanate (iii) is a biuret polyisocyanate.

5. The multi-layer laminate according to claim 1, wherein the (meth)acrylate having one or more hydroxyl groups in the molecule (i) and the (meth)acrylate having two or more (meth)acryloyl groups in the molecule are the same molecule.

6. The multi-layer laminate according to claim 1, wherein the resin layer comprising the polymerization product of the curable resin composition is formed on the acrylic anti-abrasion coating layer by performing radiation curing and thermal curing on the acrylic anti-abrasion coating layer of the curable resin composition.

7. A manufacturing method for a multi-layer laminate comprising the steps of:
preparing a substrate having an acrylic anti-abrasion coating layer on at least one surface;
preparing a curable resin composition including:
(i) a (meth)acrylate having one or more hydroxyl groups in the molecule;
(ii) a multi-functional (meth)acrylate having two or more (meth)acryloyl groups in the molecule;
(iii) a polyisocyanate having three or more isocyanate groups in the molecule; and
(iv) a photoinitiator;
applying the curable resin composition on the acrylic anti-abrasion coating layer;
radiation curing the curable resin composition; and
thermal curing the curable resin composition.

8. A manufacturing method for a multi-layer laminate comprising the steps of:
preparing a substrate having an acrylic anti-abrasion coating layer on at least one surface;
preparing a curable resin composition including:
(i) a (meth)acrylate having one or more hydroxyl groups in the molecule;
(ii) a multi-functional (meth)acrylate having two or more (meth)acryloyl groups in the molecule;
(iii) a polyisocyanate having three or more isocyanate groups in the molecule;
(iv) silica nanoparticles as a filler; and
(v) a photoinitiator;
applying the curable resin composition on the acrylic anti-abrasion coating layer;
radiation curing the curable resin composition; and
thermal curing the curable resin composition.

9. A curable resin composition comprising:
(i) a (meth)acrylate having one or more hydroxyl groups in the molecule;
(ii) a multi-functional (meth)acrylate having two or more (meth)acryloyl groups in the molecule;
(iii) a polyisocyanate having three or more isocyanate groups in the molecule; and
(iv) a photoinitiator.

10. The curable resin composition according to claim 9, wherein the curable resin composition further comprises (v) silica nanoparticles as a filler.

11. The curable resin composition according to claim 9, wherein the polyisocyanate (iii) is a biuret polyisocyanate.

12. The curable resin composition according to claim 9, wherein the (i) (meth)acrylate having one or more hydroxyl groups in the molecule and the (ii) multi-functional (meth)acrylate having two or more (meth)acryloyl groups in the molecule are the same molecule.
